(19) United States
(12) Patent Application Publication
(10) Pub. No.: US 2004/0019610 A1
(43) Pub. Date: Jan. 29, 2004

(54) Portal information delivery system for personal computers and SOHO computer systems

(76) Inventor: Kevin S. Burns, Florence, MT (US)

Correspondence Address: ELLIOT B. ARONSON, 5001 HARBORD DRIVE, OAKLAND, CA, 94618

(21) Appl. No.: 10/383,819

(22) Filed: Mar. 7, 2003

Related U.S. Application Data
(63) Continuation-in-part of application No. 10/157,417, filed on May 28, 2002, now Pat. No. 6,658,418.
Application No. 10/157,417 is a continuation of application No. 09/478,577, filed on Jan. 6, 2000, now Pat. No. 6,460,040.
Application No. 09/478,577 is a continuation of application No. 08/810,949, filed on Feb. 27, 1997, now Pat. No. 6,014,137.
(60) Provisional application No. 60/012,341, filed on Feb. 27, 1996.
(60) Provisional application No. 60/362,775, filed on Mar. 7, 2002.

(51) Int. Cl. G06F 7/00

(52) U.S. Cl. 707/104.1

(57) ABSTRACT

A portal information delivery system that provides one or more computer screens containing information content selected by a user and/or manager of the system in layouts also selected by the user and/or manager and that is suitable for use by individuals, small offices and home offices. The system provides for customizable selection of information content from third party information providers as well as from private information content that may be located on a SOHO computer system and personal information content that may reside on an individual personal computer. The system includes a content manager, a layout manager, and may also include connections to an access site for access to other content and services. The content manager and layout manager enable the user to organize and manage personal and business content on a SOHO computer system including content on individual personal computers making up the system. The system may be used on a single computer to organize and manage information content present on the computer with or without connection to the web for access to third-party information providers.

This application is a continuation-in-part of co-pending U.S. patent application Ser. No. 10/157,417 filed May 28, 2002, which is a continuation of patent application Serial No. 09/478,577 filed Jan. 6, 2000, now U.S. Pat. No. 6,460,040, which is a continuation of patent application Ser. No. 08/810,949 filed Feb. 27, 1997, now U.S. Pat. No. 6,014,137, which in turn claims the benefit of provisional application No. 60/012,341 filed Feb. 27, 1996. This application also claims the benefit of provisional application No. 60/362,775 filed Mar. 7, 2002.

### BACKGROUND OF THE INVENTION

The present invention relates to information delivery systems and is more particularly directed to a portal system for providing one or more computer screens containing information content selected by a user and/or manager of the system in layouts also selected by the user and/or manager and suitable for use on an individual computer or a small office or home office computer system.

The corporate portal has become a valuable tool in controlling the profuse amounts of company information in the form of accumulated data, reports, word processing documents, spreadsheets, drawings, and the like that may be dispersed throughout a large corporate enterprise. Corporate portals are used to collect and distribute the accumulated work product of a company as embodied in its documents, computer files and services along with links to pertinent information and services on the World Wide Web to appropriate groups or individuals inside or outside the company. Employees within the company may gain access to the customized information content they need in a convenient form over the company's internal computer network (“intranet”), and company clients, account holders or vendors gain access to customize collections of data and files pertinent to them over an outside company network (“extranet”).

Some portal arrangements permit a user to select customized information categories to be displayed on one or more portal interface screens and further allow the user to customize the appearance of the interface screens and layout of the information content on the screens. A customizable information delivery system of this sort is disclosed in U.S. Pat. No. 6,014,137 issued Jan. 11, 2000 and U.S. Pat. No. 6,460,040, issued Oct. 1, 2002, both in the name of the present inventor and commonly assigned to Datamize LLC. The disclosures of those patents are incorporated herein by reference. The present disclosure relates to the use of these principles and techniques for small office and home office (SOHO) computer systems and individual computers.

Such small offices and individuals have not generally taken advantage of corporate portal software because of such factors as cost, insufficient computer infrastructure, lack of technical know-how, lack of personnel, or time to manage such a system. Yet individuals and small businesses have the same general needs for information management on their SOHO computer systems and personal computers as larger companies and in many cases have even a greater need since individuals and small businesses often have not instituted policies and procedures for organizing, backing up or archiving files and do not have dedicated personnel for oversight of information management. Moreover, even small businesses could benefit from the features of corporate portal systems that make customized selections of information content available over the World Wide Web to authorized customers, account holders, vendors and employees.

### SUMMARY OF THE INVENTION

The present invention provides a portal information delivery system that provides one or more computer screens containing information content selected by a user and/or manager of the system in layouts also selected by the user and/or manager and that is suitable for use by individuals, small offices and home offices. The system provides for customizable selection of information content from third party information providers as well as from private information content that may be located on a SOHO computer system and personal information content that may reside on an individual personal computer.

The system includes a content manager, a layout manager, and may also include connections to an access site for access to other content and services. The content manager and layout manager enable the user to organize and manage personal and business content on a SOHO computer system including content on individual personal computers making up the system. The system may be used on a single computer to organize and manage information content present on the computer with or without connection to the web for access to third-party information providers.

It is an object of the invention to provide a customizable information delivery system that enables the user to select information content from a plurality of sources including such sources as third-party providers, private company intranets, and even the user's personal information content on the user's personal computer.

It is another object of the invention to provide such an information delivery system as a locally hosted system in which the controlling software runs locally on the computer system and the content selection is maintained locally.

It is another object of the invention to provide such a system as a web-hosted system supported by a portal application service provider in which local content is maintained in a data store at the service provider accessible via a communications link such as the World Wide Web or other Internet or global computer network connection.

It is another object of the invention to provide a web-hosted system in which both local content and web content are maintained in a data store at the service provider.

It is another object of the invention to provide a business method by which content management and content sharing services are made available over the World Wide Web in accord with the portal system disclosed herein.

It is another object of the invention to provide a local content search engine for finding and categorizing information content resident on the local computer system for use with the portal system.

Other aspects, advantages, and novel features of the invention are described below or will be readily apparent to those skilled in the art from the following specifications and drawings of illustrative embodiments.

### BRIEF DESCRIPTION OF THE DRAWINGS

FIG. 1 is an overall block diagram of a system for utilizing the invention.

FIG. 2 is a flow diagram showing content selection and management.

FIG. 3 is a flow diagram showing interface screen layout selection and management.

FIG. 4 is a representative flow diagram for the content manager software.

FIGS. 5A and 5B taken together provide a representative flow diagram for the content manager selection engine software.

FIG. 6 is a screen shot of an example Create Page dialog box.

FIG. 7 is a screen shot of an example Page Attribute Setting dialog box.

FIG. 8 is a screen shot of an example Category Selection dialog box.

FIG. 9 is a representative flow diagram for the layout manager software.

FIG. 10 is a screen shot of an example Content Layout dialog box.

FIG. 11 is a diagrammatic representation of a locally hosted system.

FIG. 12 is a diagrammatic representation of a web-hosted system.

### DETAILED DESCRIPTION OF ILLUSTRATIVE EMBODIMENTS

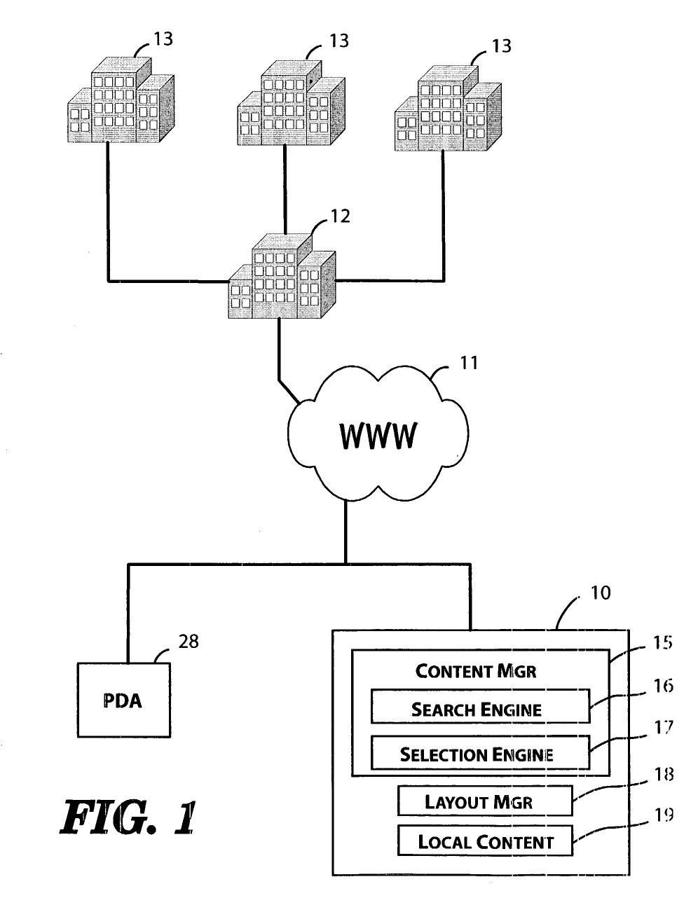

FIG. 1 illustrates a computer system 10 for utilizing an information and service delivery system according to the invention. Computer system 10 may be as simple, as a single desktop computer or even a single notebook computer. It may also comprise a plurality of computers utilizing shared resources as in a work group or linked in a server-based network or in some other way such as found in many offices or other work environments. The system can include or operate with other communications devices such as personal digital assistants (PDAs) or mobile telephones. It may even include apparatus not conventionally included in office computer systems such as set-top boxes, computer appliances, or automated teller machines. As will be evident from the descriptions below, a great variety of computer systems may take advantage of the invention so that the nature of the computer system that may utilize the invention is not intended to be limited in any way. Nevertheless, the invention may advantageously be used in SOHO systems to conveniently and affordably bring the rich functionality of a portal system for accessing information and services to the SOHO office.

In FIG. 1 computer system 10 is connected to the World Wide Web 11 for communication with a portal application service provider 12, which in turn is in communication relation with a number of content providers 13. Computer system 10 is sometimes referred to herein as the “local” system to distinguish it from the system employed by portal application service provider 12 although local system 10 may itself involve computers dispersed over a large geographic area and include mobile units such as PDAs, telephones or notebook computers. Although FIG. 1 refers to the World Wide Web, the system can also operate through other internet-based services or over other meta-networks such as other global computer networks or private or governmental meta-networks. For ease of discussion reference is generally made herein only to the “World Wide Web” or to “web-based” resources and such other system, and networks shall be understood to be alternatively or additionally encompassed.

The portal system of the invention may be operated in two different modes. One is a so-called locally hosted mode, in which software for hosting the portal is resident somewhere on local computer system 10. In this mode an Internet connection is not required, even though illustrated in FIG. 1, but much greater content and services will be available if such a connection is established. The other is a web-hosted mode, in which the portal hosting software is resident at least in part on a web-based server such as may be provided by portal application service provider 12.

The portal disclosed herein provides for the selection of content from a variety of information and service sources, both local and web-based, and customized selection of the layout by which that content is displayed. The selection of content is governed by content manager software 15, which in turn includes a local content search engine 16 and a content selection engine 17. Search engine 16 searches for content on the local computer system although, as explained more fully below, it may not itself be resident on that system. The selection of the layout is governed by layout manager software 18.

Content manager 15 permits the user to define customized content of interest to the user derived from a variety of sources, principally from the local computer system and from an external source providing access to content from third-party providers 13.

As a preliminary step, local content search engine 16 searches for and organizes the content on the local system into categories for presentation to the user. In known web-based portal systems for example, a user desiring to set up a personal portal page or to revise such a page is presented with various subject matter categories-for example, news, business and finance, and arts and entertainment, to mention just a few-from which to select content to be included in the portal page. Selection of any one of these categories may lead the user through a tree of subcategories to the desired content to be included. The tree of categories and subcategories presented to the user has been pre-defined by the portal provider. For content on local computer system 10 no such pre-defined category structure exists. An appropriate system of local content categories is defined by the user with the help of local content search engine 16.

For example, search engine 16 first determines what data storage devices are available on the local system. This may be as simple as a single hard drive in a one-computer system or it may include a number of drives on one or more computers, external storage devices on a network, removable storage devices such as CDs, floppy disks, or memory sticks, or storage area network; devices. An authorization scheme permits multiple levels of access to storage media so that a user without sufficient authorization will not be able to select content from certain storage locations. The user is then prompted to choose which drives to search. Content manager 15 maintains a local content data store 19, in which it stores a category structure and associations between files and categories. The content manager can accommodate a category structure of any configuration or complexity. The category structure may conveniently be defined by maintaining a table or series of related tables establishing the necessary associations. Local content data store 19 is indicated diagrammatically in FIG. 1 as a single block labeled “Local Content.” In fact, the physical nature of data store 19 may vary greatly from system to system and in any given system may comprise one or more different physical storage devices and storage locations and may include mirrored systems and semiconductor memory. Local Content is distinguished by the availability of the content to users of the local system rather than by the nature of the storage medium. In general, it refers to that content which is normally available to users of the local system without going on to the Internet. So, for example, Local Content includes the usual word processing files, spreadsheet files, image files, or portable document format (pdf) files, to mention only a few, that users call up in the normal course of using the local system without having to go on to the Internet. Local Content may include files that were downloaded or copied from the Internet at one time and were saved in a manner that makes them available to users of the local system in their normal course without having to access the Internet. By way of example, Local Content does not include files that are in so-called temporary folders such as temporary Internet files and not intended to be accessed by users in the ordinary course.

A large number of files may reside on the computer system and organization of these files into categories can be a complex task. In one scheme Search engine 16 provides several features to simplify this task. In the first instance, a default categorization is offered. A default categorization may be readily achieved by simply adopting the pre-existing directory structure giving the hierarchy of folders and subfolders defined on the various storage devices that are searched. Alternatively, other schemes may be used for a default categorization, for example, for computers using a Microsoft Windows® platform the desktop icons or the program listings from the “Start” menu could be used to define initial categories. Additionally, search engine 16 enables the user to define and populate categories by using keywords to characterize a category and then searching for those keywords in file names and/or file content to place the files into the associated category. As an alternative aid to categorization, search engine 16 provides for rule-based categorization, in which the user defines rules for putting files into categories based on Boolean search criteria. The local content search engine may also permit the user to deselect certain files types in the search. For example, if the user is only interested in so-called data files such as text files, word processing files, spreadsheet files, or image files, the user may select not to search for program files. The search engine will then skip .exe, .dll and other file extensions characteristic of program files. Even here, however, a technically minded user may want to establish categories including certain program files so it is desirable for search engine 16 to maintain some capability for searching program files as well as data files.

Search engine 16 may also present files for categorization by file type via file extensions. The search engine searches for the various file extensions and prompts user to select the file types the user wishes to have included in the local content categories. This may be achieved for example by means of a series of check boxes presented to the user although other selection schemes may be used. Once the user has selected the check boxes of interest, the user activates an import command and the specified content is imported into the available local content, which is stored in local data store 19. When a file is imported into the local content, the user is then able to annotate the file or category, add comments or metadata, place version control on the file, and control other attributes as well, which are associatively stored with the file in the local data store. This annotated content will then be available for selection by the user when setting up the user's customized content.

Once an initial local categorization is achieved, that is, categorization of local content, the user is able to manually revise the categories and associated content. So for example search engine 16 may provide for drag and drop categorization by which a user may place files in categories or subcategories one by one or in highlighted groups. As new files are created, the user is prompted to specify a category on the happening of some specified event, for example, the first time the file is saved. It is not necessary that all files be placed in categories, and one file may be associated with one or more than one category. As files are assigned or re-assigned to categories, the data structure in local content data store 19 is updated.

Local content data store 19 is also able to assign other links to categories besides whole files existing on the local computer system. For a system 10 that is connected to the Internet the user may specify destinations on the World Wide Web, and local content search facility 16 will cause a link to be stored along with the local content. Thus, search facility 16 is capable of maintaining a rich data store of local content that is available for selection on the SOHO portal. Even with no connection to the Internet and even on a single notebook computer with one hard drive, the local content may provide a rich data store of files in an overall category structure of great utility to the user.

In addition to storing associations between files and categories, local content data store 19 also stores associations between file extensions and software applications used to open files of that extension type. As a default, the content manager associates files wish applications based on the current file associations on the computer system. The file associations may be changed at any time through the content manager. Search engine 19 maintains its own table of file extension associations and does not alter the associations otherwise maintained on the computer system.

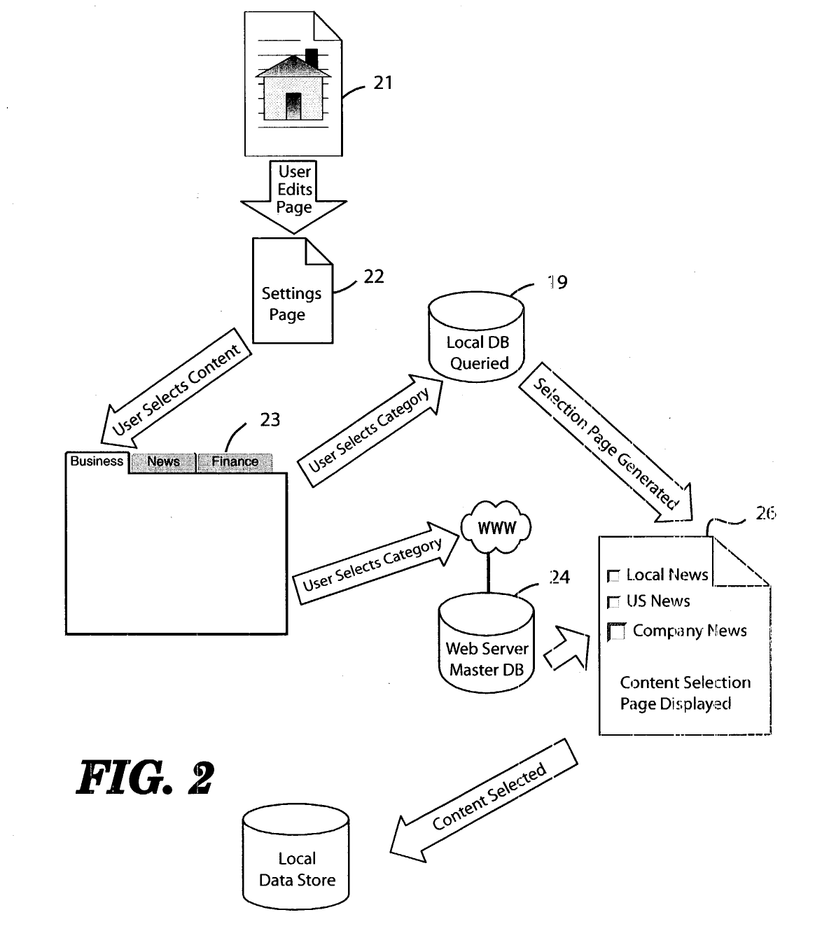

Once the local content is established, the user is ready to select customized information content and to select a customized layout for presentation of the selected information content. FIG. 2 shows a high-level flow diagram of the content manager selection engine 17 for the customized content selection operation. When the portal software of the present invention is started up, a home page 21 is displayed. If no home page has been specially designed yet, a default page is shown. The user may then select to edit the page such as by activating a control displayed on the home page. The result of the user selecting to edit the page is illustrated in FIG. 2 by a settings page 22 through which the user selects to edit content by activating the content manager. Settings page 22 is shown only diagrammatically in FIG. 2 and need not constitute a separate page in any given realization of the software. It may be realized for example as a separate dialog box or even as two buttons on the home page or on a header for “edit content” or “edit layout.”

In the illustrated embodiment the content manager selection engine is configured as a so-called wizard for use on a Microsoft Windows® platform although no limitation to this particular platform is intended. As is familiar from other Windows® applications, the wizard walks the user through the steps for selecting content. After displaying its opening page the wizard presents the subject area categories that are available for selection, for example, business, news, or finance seen at reference numeral 23. The user selects a category, for example, news. The content manager then searches the local content data store 19 for the local content and, for the embodiment in which the user system subscribes to a web provider, the content manager also initiates a search of a master data store 24 maintained by the web provider for further content falling within the selected subject matter category. The search hits are then presented to the user as subcategories, for example, company news, local news, international news, available for selection at reference numeral 26. The user exercises a choice through the check boxes or by other means, and the user's customized selection is then stored in association with the page on which it is to be displayed. In different embodiments the customized content may be stored in the local data store 19 or in a separate data store on the master web site or other server. The news example presented here is offered as a simple illustration. The available subcategories may be broken down further and presented in more complicated hierarchical schemes. The local news may be broken down for example into specific local news sources available for selection.

Thus far only passive information content has been discussed. However, the pages may equally well include active controls such as buttons or hot spots for initiating various other applications or actions or for providing access to web-based services. In the Billing and Receivables pages, for example, a button could be included for activating the user's accounting software. Where the accounting software permits, more detailed actions from within the accounting package could also be linked to an activation site such as a button or hot spot on the pertinent page, such as “generate invoice,” “receive payment,” or “add client.” Another user may choose to have pages titled Finance or Schedule/ToDo through which the user accesses tax and finance applications or Personal Information Manager with ToDo list and Calendar applications.

Any number of pages may be set up in this manner. The user may specify controls on each page providing links to other pages. The user may establish separate pages for specific topics, providing a name for each page. For example a self-employed individual with a home office may want pages such as Billing, Receivables, Clients, Personal and the like. These pages could then be populated with content from the local Content store that displays billing reports, receivables reports and various client matters. These pages may also include content downloaded from the master web site, for example, the personal page may include local news, or news from the relevant trade press.

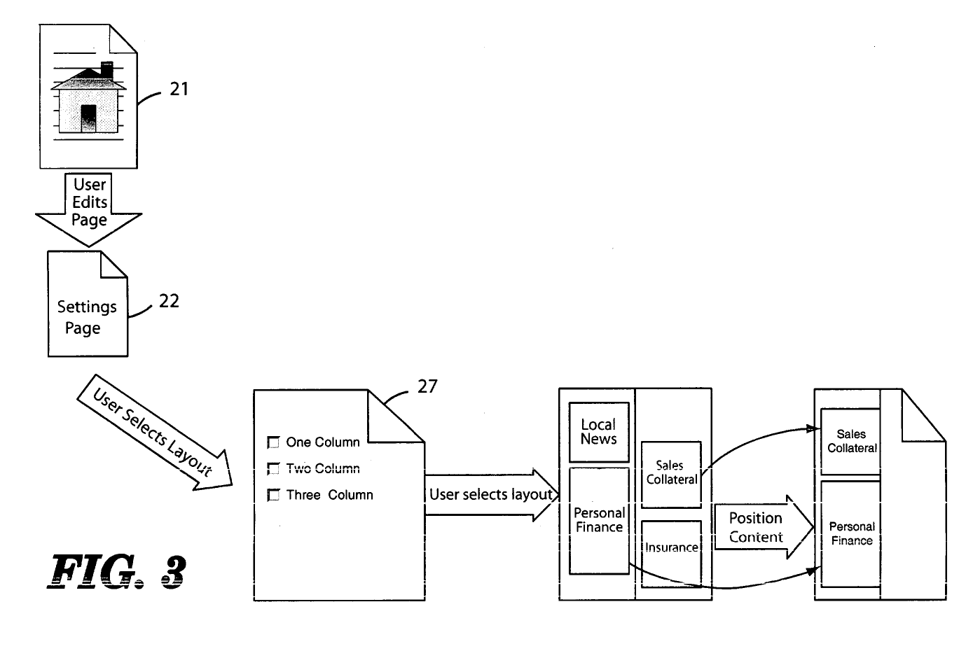

Once the content for a page is selected, the layout manager is activated for formatting the page. FIG. 3 shows a high-level flow diagram of the operation of the layout manager, which is reached through settings page 22. When setting up a page, the user can choose a page template at reference numeral 27, for example a one-column, two-column, or three-column template. Various features may then be customized such as background colors, font styles and sizes, heading styles, border styles, use of thumbnail views, highlighting color, location of controls, control styles, image sizes, and the like. At this point the pages can also be branded with a company name or logo or personalized with a background wallpaper picture or style, or other special personal touches. While the layout manager allows for great variation in the page layouts, including great variation in the on-screen characteristics of the layouts, it is nevertheless generally desirable that the layout manager impose constraints on the possible layout templates and on-screen characteristics. This will make it easier for a user to set up a page layout because the user will not have so many decisions to make; that is, most of the page layout will have been pre-defined by the constraints with only limited choice being left for the user. In addition, a professionally designed look and feel can be built into the pre-defined templates and constraints so that the user's resulting pages will have the benefit of a professional design, notwithstanding the range of variability in layout offered to the user, without the user ever having to retain a professional designer. A limited selection of page templates with constraints on the on-screen characteristics will be preferred by many users.

Building limitations on the permissible layouts into the layout manager will be a desirable feature in many circumstances. For example, in portal systems intended for use in the typical SOHO system or individual computer, most users will want to get their pages up and running quickly and easily and will not want to have to design their own layouts from the ground up. As a practical matter, the pre-defined layouts and constraints enhance the ease of use of the portal system to the majority of users, and this is particularly beneficial on the typical SOHO system or individual computer where the users generally do not have trained MIS personnel available to assist them. Nevertheless, there are those who would prefer to have greater control over the customization of layouts than provided by the pre-defined layouts and constraints. The layout manager may include a designer mode in which the user is able to build the layouts entirely from the ground up and may include an intermediate mode providing greater freedom to the user while still providing master templates or other design guides for the design of the layouts. The layout manager may also import page designs created with other software applications.

The content previously selected for the page may be placed on the page in the desired location. For example, each category of information (with or without an appropriate label) may be placed on the screen at a position within a selected column and at a selected vertical position within the column. FIG. 3 illustrates the use of a drag and drop method of placing content in desired locations on the screen. Content need not be placed by category, but may alternatively be placed one element at a time wherever the user prefers. Once the content is selected, the user can arrange the layout of the content, for example, by moving it from one column to another or changing its position vertically within a column. Suitable techniques for selecting layout and associated content are disclosed in the aforementioned U.S. Pat. Nos. 6,014,137 and 6,460,040.

Once the home page is completed, additional pages may be created in the same manner. In some cases the content may be readily available and embedded within the page, such as a Microsoft Outlook calendar. In other cases a descriptive link such as a file name and description may be used to activate the linked application and load the file. The user may also activate various script features within a page such as JavaScript modules.

Implementation of the invention may be carried out under any of the popular Windows® operating systems with Microsoft Internet Explorer 5.0 or Netscape 6.0 or greater. The application runs within the web browser. In addition, it is simplest for the system to run a stand-alone database application such as Microsoft Access, SQL Anywhere or the like. On the client side the software is implemented using JavaScript, DHTML, HTML, XML and ActiveX, as well as other languages such as Java, C# or Visual Basic. To install the software and execute the setup wizards, known MFC/C++ helper applications are readily available.

In the locally hosted mode the personalized portal application of the present invention may be used without an Internet connection simply as a way of finding and managing information content available on the local system. This may already be of advantage on an individual computer or on a small computer network such as often found in small offices. In addition, while still operating in the locally hosted mode, the portal application may also be used in conjunction with a web-based content server such as illustrated conceptually at reference numeral 12 in FIG. 1 to make content available through the portal pages from a variety of web-based or other resources such as the plurality of content providers 13 illustrated in FIG. 1.

In the web-hosted mode the portal application of the present invention provides for sharing the local content, along with web-based content, across multiple employees, clients, vendors, or other users authorized to receive such content. In this mode the local content data store, which is to be shared among computers, is maintained at the web server of the hosting portal application service provider. As a practical matter the local content data store will generally reside on both the local system and on the hosting system. In this way the user can use the portal system to access and update local content even when the system is not connected to the Internet. The local content data store may then be uploaded to the hosting system on a regular basis. Since the local content is maintained in a data store at the hosting web site, the user is able to access the portal from any computer or other communications device that is web-enabled such as the PDA device 28 in FIG. 1, and several users, such as several employees or customers of a small business, are able to access the same customized page. In this way event small business can set up a series of customized portal pages aimed at its employees and its customers or others that may be accessed remotely and shared by those with rights to the page. Storage of local content on the web server also provides the additional benefits of security and regularly maintained backups. Both local content and web content can be automatically updated by actions initiated at either the client or the server.

Customization of page content and layout may proceed in the web-hosted mode as follows. Portal application service provider 12 provides a user interface for selection of content that presents content categories for selection. The user will be able to select from content provided directly by portal application service provider 12, from content provided by third-party providers, as well as from the local content and applications. When a user requests third party content, a page is generated from the portal application service provider's master data store of third-party content. The user selects categories of content from the page, which may then cause additional pages to be generated with subcategories of content. From these category pages the user will make a content selection. Based on the user's third-party content selection, a record is made for that user and that page. The page record is stored on the local system with a reference to the content on the portal application provider's web server. When the user loads that page, a request is sent to portal application service provider 12, which performs a data store lookup. The data store may either store the third-party content itself or a reference to the content, depending on the arrangement with the third-party provider. If a reference is stored, then the content request is redirected to the appropriate third-party content provider 13. Portal application service provider 12 may also maintain additional pre-defined layout templates for the user's use in defining page layouts, but the user may also use templates provided by the layout manager 18 or define his or her own layouts. The user's customized layouts are uploaded to the server.

The local system replicates its local content to the portal application service provider host. The replication can be made to occur automatically so that whenever a change is made to the primary local content portal at the local system, the change will be replicated to the host, thereby making the content accessible via the web. In general, when a user uploads local content, the individual files will be converted to XML format, HTML format, or comparable standard format. By way of example, the local content may include a Microsoft Word® document, and a properly authorized user may wish to view this document from a device, say a PDA, not able to read the .doc file type. Conversion of the local content to a standardized format such as XML, enables the portal application service provider to make the local content available in readable format to the largest audience of authorized users. The local content may also be retained in its original uploaded format so that properly authorized users may be enabled to receive the original file type.

In the web-hosted mode when the user activates the portal software, an http get request is sent to the portal application service provider. Authentication may proceed as follows. If the local device from which the user contacts the host is itself an authorized device, it may contain a cookie including the user's name and a user ID. The user name and ID are then sent automatically to the host permitting authorized access. If no such cookie is present, either because the local system chooses not to use cookies or because the user is at a remote device such as a web-enabled telephone or a foreign computer, then the device is presented with a log-on screen, by which the user may enter a user name and ID. As used herein, user name and ID may refer to individual persons or individual machines or even groups of persons or of machines may share a common user name and ID. A request for a page is then sent to the server. The request may take the form, for example: http://“host URL”/page.asp?username=“user name”;id=“ID”, where the identifying designations are substituted for “host URL,” “user name” and “ID”.

To generate the requested page, the web hosting software receives the user ID, gets the layout page for that user ID, looks for items of information or service content, pre-defined user controls or other user interface elements called for by the layout page, combines those items with the layout page by putting the information or action items into layout page at the positions of appropriate place holders, and transmits the completed page in HTML, XML or other page definition format to the requesting user.

For the locally hosted mode the operation is much the same. Local web hosting software is commercially available such as the Microsoft Internet Information Server (IIS) software or the Microsoft Personal Web Server software. Such software packages provide the functionality for http access, TCP/IP protocols, and implementation of standard web services such as ASP support, active server page support, XML parsing and more. Requests for pages and authentication are handled much the same as for web-hosted servers. The initiating request to the local system takes the form: http://“localhost”/page.asp?username=“user name”;id=:“ID”, where “localhost” refers to the designation of the local host computer in the local system in the syntax of the particular software package used.

A more detailed description is now given of software methods, functions and processes for implementing the procedures of the invention. For purposes of illustration these various methods, functions and processes are described in terms of pseudocode. The pseudocode may be implemented in any convenient programming language or programming style. The functions discussed below are offered to illustrate a substantial implementation of the software methods described herein. Additional functions needed to complete these tasks are of a routine nature and readily familiar to those of routine skill in the art and need not be disclosed in any detail here.

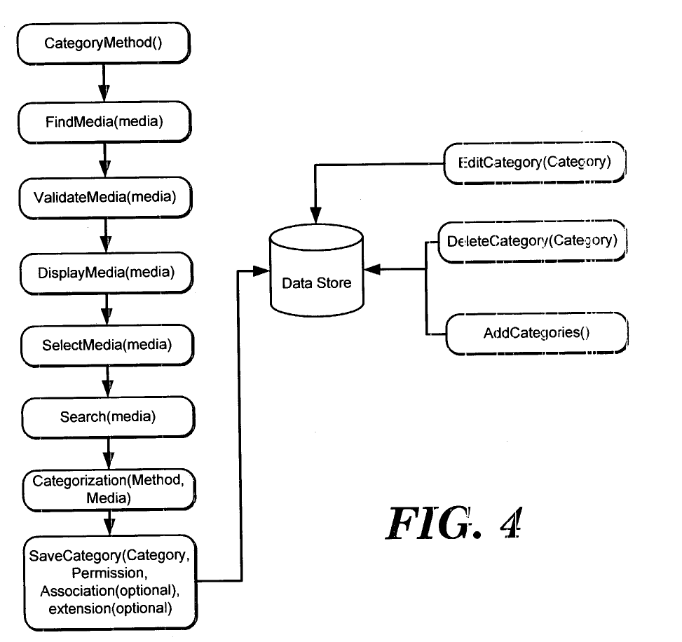

First, the content manager is discussed with reference to FIG. 4. The content manager search engine determines where content may reside. This is accomplished by a call to a function such as FindMedia( ) which searches the local system and any networked devices for storage media and provides an identifying list of the media found. A sample function is given in Table I.

TABLE I
FindMedia

FindMedia(media)
{

Query host for media sources
If CD

Add CD device

If DVD

Add DVD device

If Floppy

Add Floppy Device

If Hard Drive

Determine logical drives

Add logical drives

If Mapped Network Drives

Add Mapped Drives

If Shared Network Drives

Add Shared Network Drives

If other media

Add media devices

/* Return list of all media devices */
Return media

}

User authorization is then determined through a function ValidateMedia, which checks whether the current user has adequate rights and privileges to each Media Device which was turned up by FindMedia. Here the Operating System is leveraged for permissions, rights & privileges.

TABLE II
ValidateMedia

ValidateMedia(media)
{

/* Determine system user */
Query OS for User
/* Determine privileges
Query OS for Group User belongs to
/* Determine what Media the user can access based on Group */
Query OS for each device and access permissions
Return media

}

A list of the media devices is then displayed which the current user has permissions to access. This is accomplished with a function DisplayMedia( ).

TABLE III
DisplayMedia

DisplayMedia(media)
{

| Create Dialog | |
|---|---|
| Display media in List Box /* | use third party list which supports two columns |

First column device, 2nd colunm checkbox*/

Return media /* return media which is selected */

}

The user then selects from the list the drives having files the user wants to search. The, functions SelectDrive and Search are provided for this purpose.

TABLE IV
SelectDrive

SelectDrives()
{

DisplayMedia()
Search()

}
Search(media)
{

for I=0; I<number of media; I++

search each media

next
Display files

}

To categorize the desired files, the user first is given an opportunity to select one of several content categorization methods. The function CategoryMethod determines the user's selection, through a number of radio buttons presented to the user.

TABLE V
CategoryMethod

Function CategoryMethod()
{

/* Select categorization wizard *
File Associations - Radio Button
File Extensions - Radio Button
Keyword - Radio Button
If (Keyword selected) then

Enter keyword

End if
Directory Structure - Radio Button
RuleBased - Radio Button
If (RuleBased selected) then

Enter Rule

End if
Manual - Radio Button
Return Method

}

At this stage the user has selected the media of interest and the method by which the categorization of files is to proceed. This is accomplished with a function Categorization (Method, Media), which returns a list of content based on the user's chosen categorization method, which is displayed to the user along with check boxes or other means by which the user can indicate whether any given file is to be retained in a category or not. The specific steps followed depend of course on the selected categorization method.

For the file associations categorization method a category is created for each file association that is found. The file associations may be determined from the operating system. A category initially takes on the name of the application with which the file is associated. So for example if a *.doc file is found, it would be placed in the Microsoft Word category. The user can then rename the category. In addition the user can create subcategories and drag and drop files from a parent category to the respective subcategories.

For the file extensions categorization method the categories are created in much the same fashion but rather than determine any file associations, the categories are based strictly on the file extension. Again once the user has gone through the automated process, the user may intervene and create any subcategories, move files around, and manually add and delete files.

For the keyword categorization method a wizard is provided that searches all authorized files looking for a keyword, which the user provides. This is an interactive process. The user enters a keyword and specifies the category for any files found with that keyword. The search take, place and the files are placed in the user-specified category. The user can then create subcategories, if desired, remove files, and so on. Thus, if a user who works for a company called Datamize were to search for the keyword Datamize, and the user provided a category name Datamize, then all documents that were found to contain the keyword Datamize would be added to the Datamize category. The end user would then be presented with a hierarchical view of these files for example according to file name and path and then be allowed to partition the files into subcategories. So the Datamize end user might provide two subcategories for Datamize, Web Site and Marketing. The user is then able to move the files around in the subcategories organizing them as the user desires. When this process is completed and the user continues, pointers to the files are added to Category and Subcategory tables.

The directory structure categorization method traverses the directory structures of the authorized media devices and creates categories and subcategories based on those directory structures. Once completed the user can modify the entries by combining categories creating new subcategories, removing categories or subcategories, and so forth.

The manual categorization method is an interactive method, in which the user uses an Explorer-like interface to view files. The files are selected and manipulated by right-clicking on the file. On right-clicking, the user gets a context sensitive menu, which allows files to be added to categories, categories and subcategories to be created, and the like. In this manual fashion the user is able to manually select and categorize the files of interest.

The content manager in addition includes a process that executes at startup and monitors the file system for new files to be categorized. The operation is based on categorization methods set by the user. In setting a categorization method, the user may also specify whether the categorization method is to be left on for future operations. So if a user has selected to categorize by directory structure and then sets the method to ON, this process continuously monitors the disk IO system. Anytime a file is added, deleted or moved the system queries the content database for the file name. If the file is found it determines the category for the directory, subdirectory, etc. If a file already exists in that category/subcategory with that name, the user is prompted to take an action, such as replace the content in the content manager. If no such file is found to exist in that category, the user is prompted whether to add the file.

The content manager maintains a category table. The categories are saved, edited, deleted and added to the category table in accordance with the functions given in Tables VI-IX.

TABLE VI
SaveCategory

SaveCategory(Category, permission, association (optional) extension(optional))
{

Open DB
Save Category to DB with permission attribute set and association or extension if present
Close DB

}

TABLE VII
Edit Category

EditCategory(Category)
{

Open DB
Check User Permissions
If (Permission)

Query DB for Category
Display record in form with save button
Update record

Else

Display Error with Appropriate Error Message

End if
Close DB

}

TABLE VIII
DeleteCategory

DeleteCategory(Category)
{

Open DB
Check User Permissions
If (Permission)

Delete Record

Else

Display Error with Appropriate Error Message

End if
Close DB

}

TABLE IX
AddCategories

AddCategories()
{

Provide Browse Capability
Browse for File
Select File
Display File Name and Drop Down with Categories
Select Category
If Category Not Present
Add Category

}

The categories are stored in a Category Table, which includes at least a CatID, the Category Name and a Category Description. A relational database may be used to implement the tables, but one could also use other methods such as XML files, in which the actual file contains the category/subcategory hierarchy.

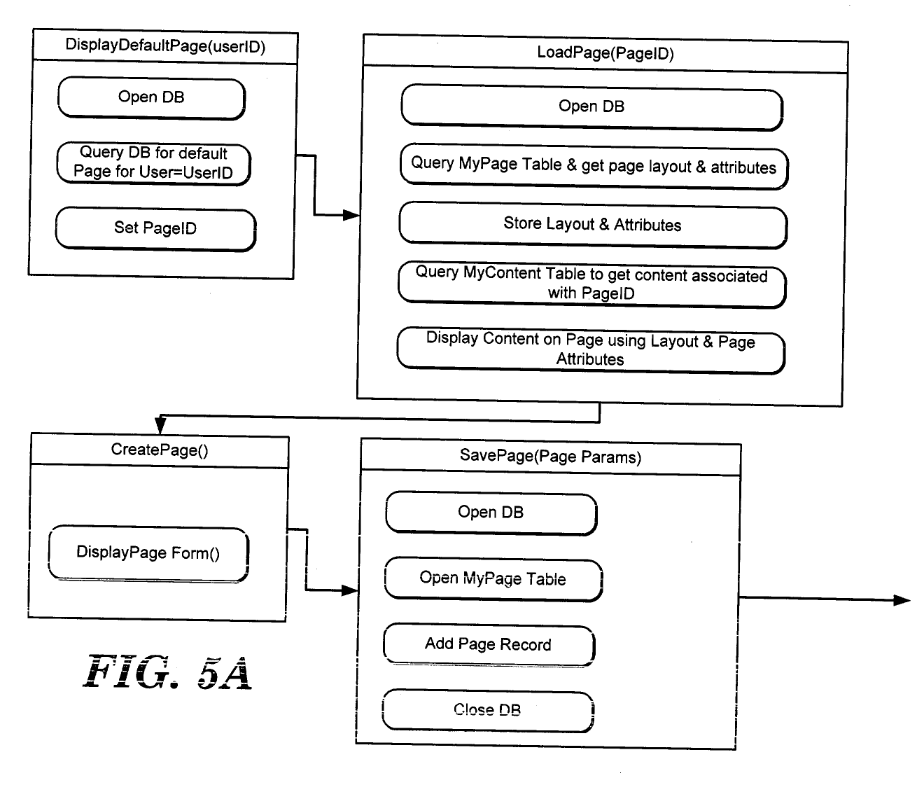

The Content Manager Selection Engine is now addressed with reference to FIGS. 5A and 5B. First, the database is searched for the default page and the page is displayed to the user. The functions DisplayDefaultPage and LoadPage shown in Tables X and XI manage the default page settings. There can be only one default page, where default page is understood to mean the page loaded on startup. So for instance if the default setting is removed from a page, the Selection Engine will require a new default page to be set prior to completing the operation. Likewise if a page is deleted, the Selection Engine will check to see if it is the default page and if so, will require a new default page to be specified.

TABLE X
DisplayDefaultPage

DisplayDefaultPage(userID)
{

Open DB
Query DB page table for the default page for UserID
Set Page ID
Call LoadPage(pageID)

}

TABLE XI
LoadPage

LoadPage(PageID)
{

Open DB
Query MyPage Table and get page layout & attributes
Store layout and attributes
Query MyContent Table to get content associated with PageID
Display content on page using layout & page attributes

}

The LoadPage( ) function queries the Data Store. First it determines the userID, which is set when the user logs on. Then it opens up a MyPage table and searches for a page with the PageID. Once it finds the Page it retrieves the information about the page such as the layout, the background, the page attributes, and the like. When that has been completed, LoadPage accesses a MyContent table and determines the content that is associated with the designated page. LoadPage not only finds whatever content is present, but also for each item of content on a page it provides the position and location of that item. LoadPage then uses this information to create a page using the location and position information to display the content on the page. Alternatively one could store these pages in XML files and use xsl, css or DHTML and XML DOM to display the pages.

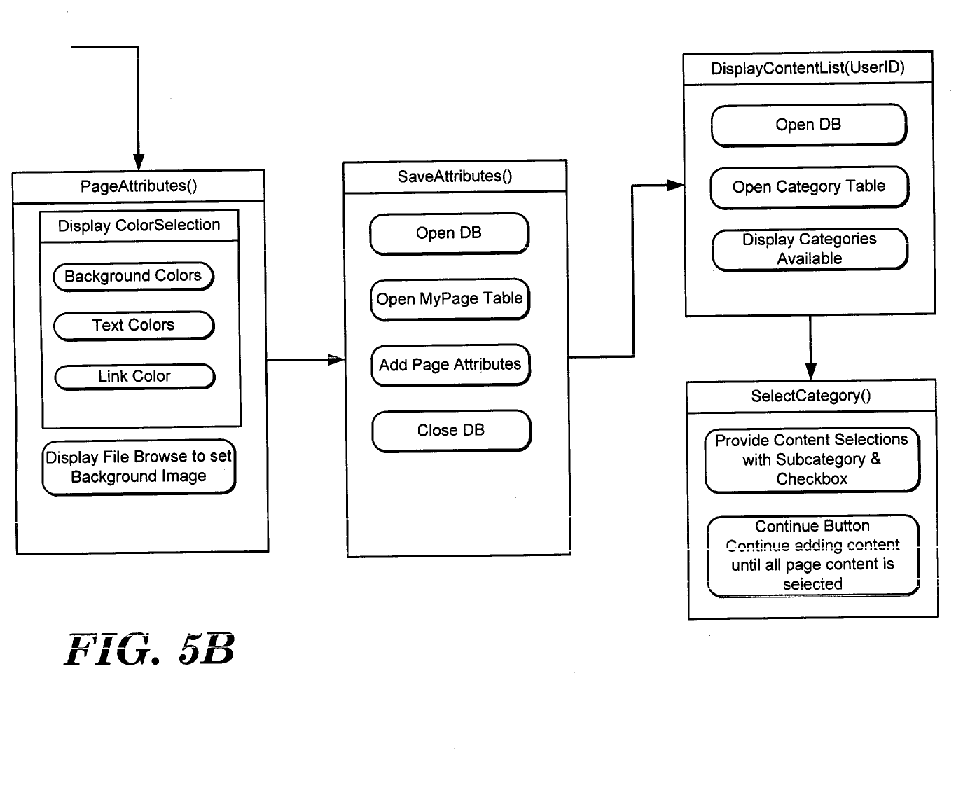

Once the default page is loaded, the user can create a new page. To create a new page the user selects Page Operations to drop down the page operations menu and selects Create Page from the menu. A CreatePage dialog box is shown in FIG. 6, and Table XII shows a CreatePage function for defining a new page.

TABLE XII
CreatePage

CreatePage()
{

Editbox(page name)
Editbox(description)
Checkbox Default Page
Permissions()
SavePage()

}

The functions called by CreatePage( ) enable the user to name the pave, provide a description, and set whether this page is to be the default page. They also enable the user to specify who has permission to view the page. The page is saved to the database by a SavePage function, an example of which is given in Table XIII.

TABLE XIII
SavePage

SavePage(createpage form)
{

Open DB
Open MyPage Table
Add a record with Page Name, Description (optional) and Default (True/False)
Close DB

}

When the user provides the page information and saves the page, a record is inserted into the MyPage table. A PageID is generated and the UserID is stored. The userID is maintained to assure that only the authorized user can get access to the page. The page is associated with a single user unless the user specifies otherwise.

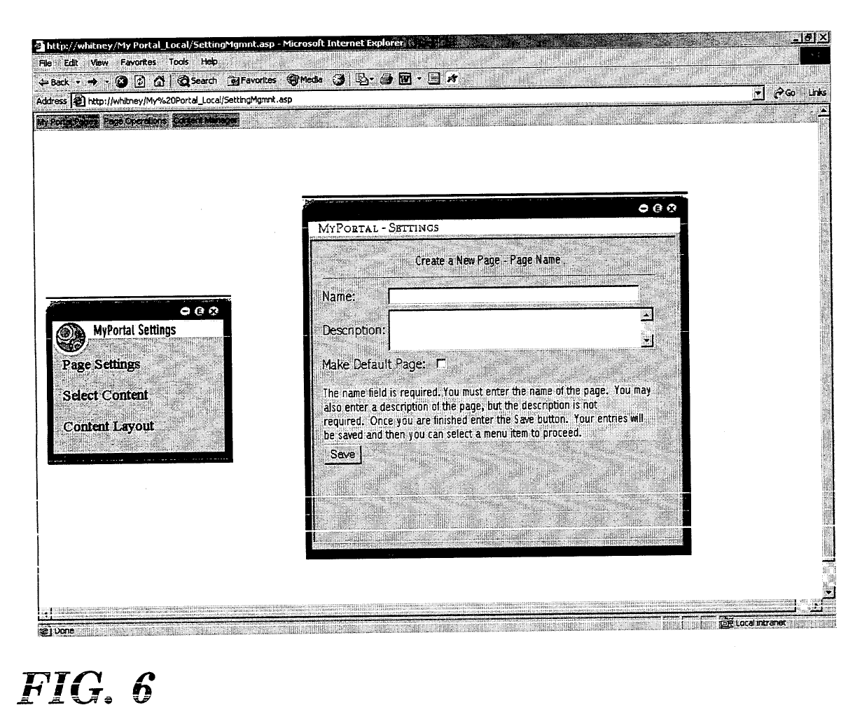

Once the page is created, the user sets the page attributes through a page attribute dialog box. FIG. 7 shows a color selection dialog box. The attribute selections are achieved with PageAttribute and SaveAttribute functions such as given in Tables XIV AND XV.

TABLE XIV
PageAttributes

PageAttributes()
{

Display Color Selection Options

Background Colors, Text Colors, etc.

Display Browse Dialog to place background Image on Page

SaveAttributes(PageID)

}

TABLE XV
SaveAttributes

SaveAttributes()
{

Open DB
Open MyPage Table
Add page attributes
Close DB

}

Once the page attributes are set, the user selects the content. This is achieved with the DisplayContentList and SelectCategory functions of Tables XVI and XVII.

TABLE XVI
DisplayContentList

DisplayContentList(UserID)
{

/* Displays Content Categories in Menu */
Open DB
Open Category Table
Display Categories Available to UserID

}

TABLE XVII
SelectCategory

SelectCategory()

Provide Content Selection with Subcategory & Checkbox
Provide continue

}

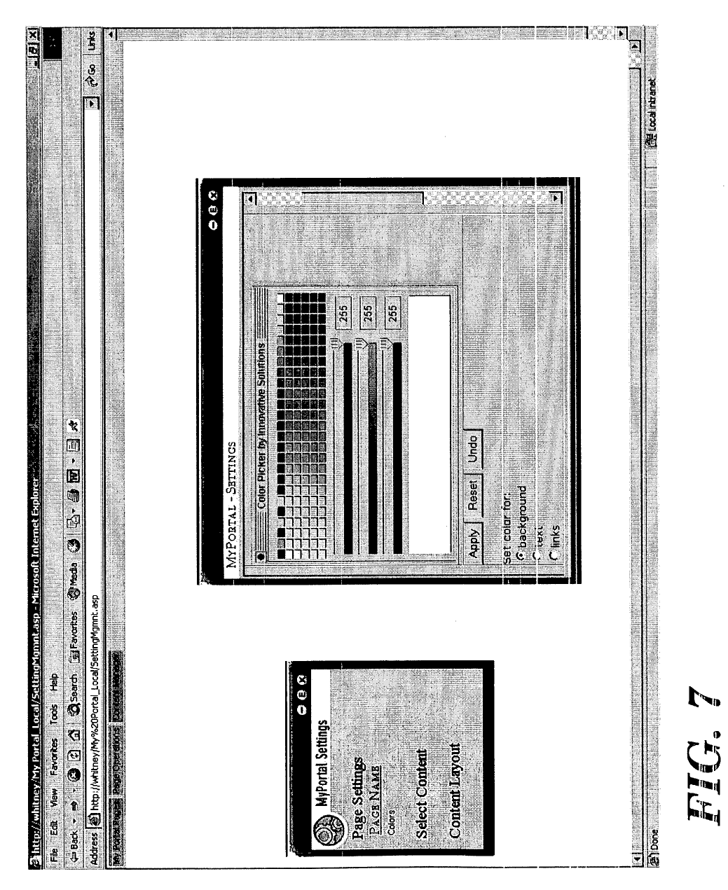

DisplayContentList queries the Category Table and determines the available categories. It then presents the categories in the form of a selection dialog box, an example of which is shown in FIG. 8. The user selects all the desired subcategories from the category. For the example of FIG. 8 the user selects the desired types of news from the News category. When this is done, the user presses the Continue key to select from the next category. The process continues until the user has selected all the desired content categories.

The user then selects the category of interest and is presented with subcategories of content within that category. The user can place a check mark next to the subcategory and press Continue to add that to the page. Or the user can click on the subcategory and Continue to progress further through the tree. When the user finds the data desired to be added to the page, the user merely selects the data and presses Continue. The content is added to the MyContent table and is associated to the page via the Page ID.

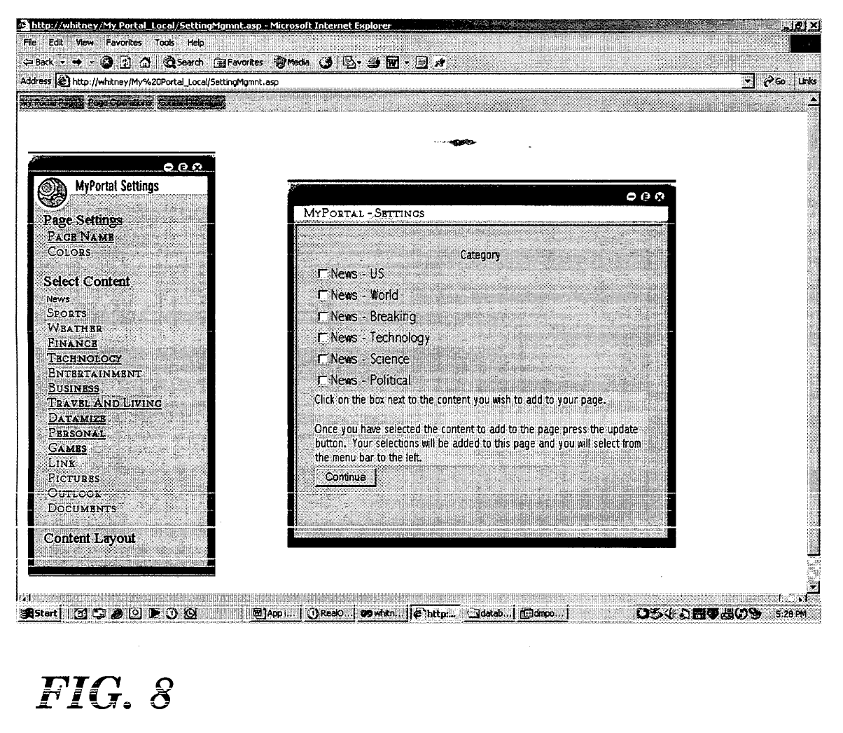

The Layout Manager is now addressed with reference to FIG. 9. When the user selects Content Layout from the menu, a SelectLayout function presents the page templates that are available for selection. The templates will typically comprise, for example, one column, two columns, or three columns, or the user could design other layout templates that provide other arrangements of content. The user-created templates are stored in the Page Layout Table. This table stores the positions of content on the page. Once the template is picked, the attributes of the template are passed to a SaveLayout function( ). Tables XVIII and XIX give examples of these functions.

TABLE XVIII
SelectLayout

SelectLayout()
{

Open DB
Open Page Template Table
Display Page Templates with a Radio Button
Close DB
Save Button

}

TABLE XIX
SaveLayout

SaveLayout()
{

Open DB
Open MyPage Table
Save Page Layout
Close DB
DisplayContentLayout()

}

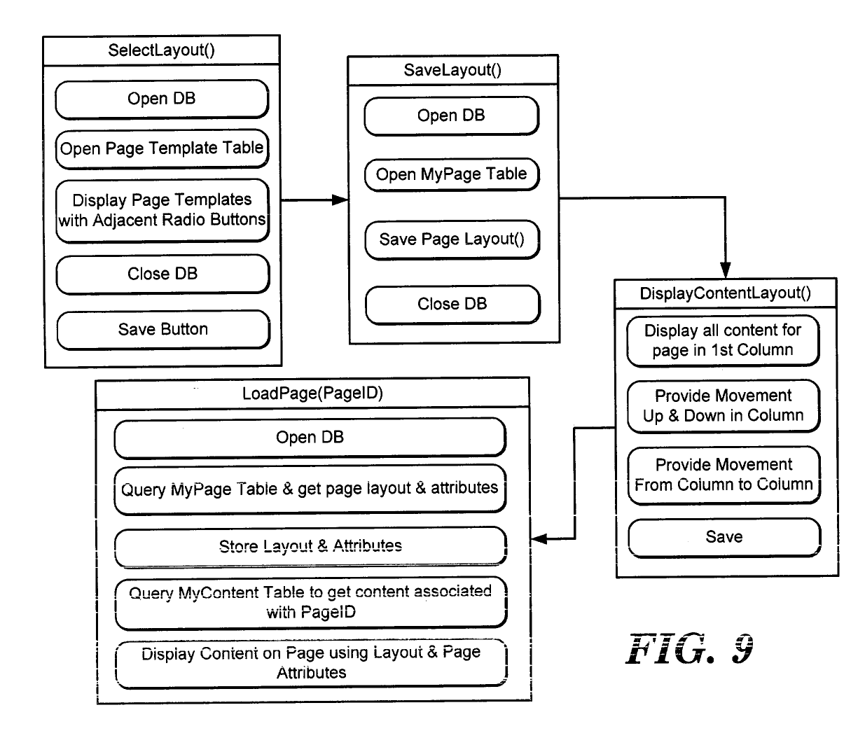

DisplayContentLayout uses the information about the template to display a form with list boxes. An example dialog box is shown in FIG. 10. The list boxes are placed on the form to represent the content on the page. Initially all the content is located in the first list box. The user can then move the content to any position, using Drag and Drop or arrow keys. Since the list boxes can be in rather random order, the arrow keys follow the tab order. Once the data is placed in the list box which represents the content, the user can use and Up and Down arrows to change the order in the list, which controls the order in which the content is displayed. Once completed, the page is saved and displayed. This is achieved with the DisplayContentLayout function as in Table XX.

TABLE XX
DisplayContentLayout

DisplayContentLayout()
{

Display all content for page in first column
Provide move up and down
Provide move side to side
Allow user to move content within column and from column to column
Save
LoadPage(pageID)

}

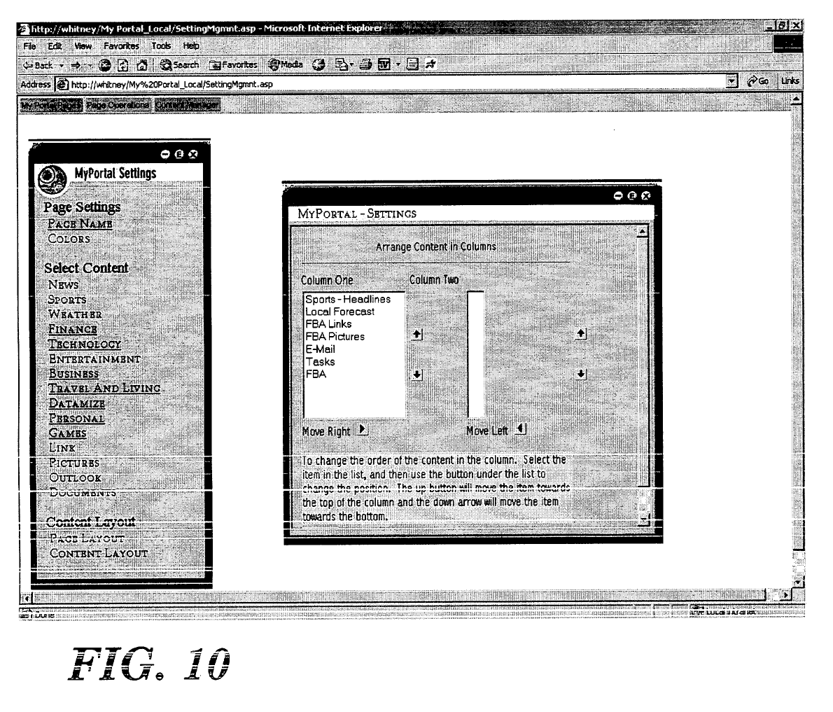

As described above, the system operates in two modes—a locally hosted mode and a web-hosted mode. In the locally hosted mode the user can have a stand-alone machine with or without an Internet connection. The locally hosted mode is shown diagrammatically in FIG. 11, which shows the locally hosted system 41 in communication with the Internet, although an Internet connection is not required. In the locally hosted system with an internet connection, however, the user can specify content from local media devices as well as from licensed content from content providers 42 who make their content available over the web and from other third party content providers 43. Pointers to all content are stored in the master database 44. In the locally hosted mode the master database is in communication with and will generally reside on the local host.

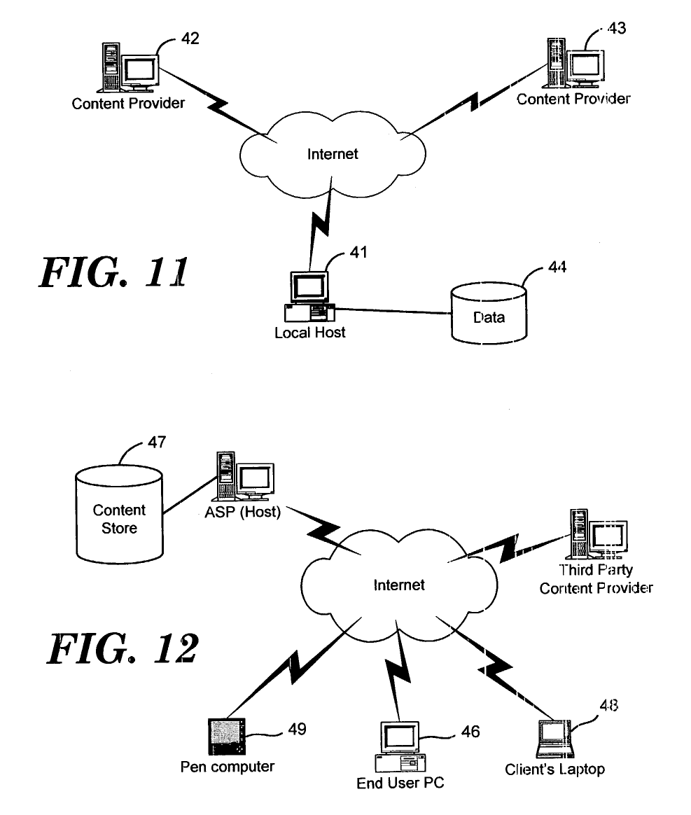

The web-hosted mode is illustrated diagrammatically in FIG. 12. In the web-hosted mode the end-user 46 needs an Internet connection. The end-user specifies content from the web and from local media sources. The content store 47 is located at the Application Service Provider (ASP), who serves as the host. An end user specifies content from the web and pointers (URLs) are stored in the data store 47. In addition the user can specify content from the user's local machine. In the case of such local content, the user can also specify content attributes. For example, the user can specify whether the content is read only. If the content is set to “read only,” other users can see the content but they cannot change the content. The content is replicated and physically copied to the media store 47. In the media store a record containing a pointer to the content along with the content attributes is created. The actual data is then stored on the file server.

Other users who have permission can access the ASP Host and view a given user's MyPortal Pages, as represented here by the client laptop 48 and pen computer 49. Content from the end user's PC is replicated to the ASP Content Store. This is achieved a Replicate function such as shown in Table XXI.

TABLE XXI
Replicate

Replicate()
{

Detemine if content is new
If new then

Copy content to Host Content Store

Else

Compare local copy to Host copy
Store Changes
Copy changes to Host Content Store

End If
Permissions()

}

TABLE XXII
Permissions

Permissions()
{

Display Users
Tag Users who have permission to access content
Save record

}

Content Selection and Layout are accomplished just as they are in the locally hosted mode, the only difference being that the user must have Internet access and the process is executed from the ASP host rather than the local machine.

Although described herein as used with a local office computer system, the present portal system may also be used in other contexts not normally considered to be such a system. For example, the portal system could be beneficially accessed through an automated teller machine. In such a case the user logs on to the ATM in the customary manner, and the authentication of the user can be passed to the host based on ATM log-on.

The above descriptions and drawings are given to illustrate and provide examples of various aspects of the invention in various embodiments. It is not intended to limit the invention only to these examples and illustrations. Given the benefit of the above disclosure, those skilled in the art may be able to devise various modifications and alternate constructions and configurations that although differing from the examples disclosed herein nevertheless enjoy the benefits of the invention and fall within the spirit and scope of the invention disclosed herein, which is defined by the following claims.

What is claimed is:

1. A method for providing customized information content for display on a computer in one or more customized interface screens, comprising:
categorizing local information content resident on storage devices local to said computer;
selecting said customized information content at least partially from the categorized local information content and at least partially from information content provided by one or more third party information providers over a global computer network; and
selecting the layout of one or more interface screens for display of said customized information content, wherein said layout is constrained to have on-screen, characteristics in conformity with a characteristic look and feel.
